(19) United States
(12) Patent Application Publication
(10) Pub. No.: US 2010/0138869 A1
(43) Pub. Date: Jun. 3, 2010

(54) METHOD AND DEVICE FOR GENERATING ELECTRONIC SERVICE GUIDE

(76) Inventors: Jun Li, Cranbury, NJ (US); Si Nan Shangguan, Beijing (CN); Yun Tao Shi, Beijing (CN); Kai Xie, Beijing (CN)

Correspondence Address: Robert D. Shedd, Patent Operations;THOMSON Licensing LLC, P.O. Box 5312, Princeton, NJ, 08543-5312, US

(21) Appl. No.: 12/451,512

(22) PCT Filed: May 21, 2007
(86) PCT No.: PCT/CN2007/001642

§ 371 Date: Nov. 16, 2009

(51) Int. Cl. H04N 5/445

(52) U.S. Cl. 725/54

(57) ABSTRACT

A method for generating Electronic Service Guide, comprising steps of: obtaining user information from a user in a digital video broadcasting network; generating a first Electronic Service Guide as a function of the user information, wherein the first Electronic Service Guide lists services provided by the digital video broadcasting network and associated with the user information; and sending the first Electronic Service Guide to the user.

### FIELD OF THE INVENTION

The present invention relates to a video broadcasting system, and more particularly, to a method and device for generating Electronic Service Guide (ESG) used in the video broadcasting system.

### BACKGROUND OF THE INVENTION

In traditional video broadcasting system including mobile TV network, such as the DVB CBMS (Digital Video Broadcasting Convergence of Broadcast and Mobile Services) network, the coverage range of the broadcasting network is a wide area generally, such as a city or a province. Therefore, the services provide by the broadcasting network are same for everywhere in the coverage range, and the fixed ESG is provided to the clients periodically. Meanwhile, through the ESG, the consumer can view, select, order and consume the services and content they are interested in.

In general, the ESG is made of the following kind of information: 1) service information, which is the list of the services and their associated characteristics, including general information and logo, conditional access information, video and audio parameters (codec, frame rate . . . ), linked interactive applications declaration, and so on; 2) Electronic Program Guide (EPG): encompasses a list of current and scheduled programs that are or will be available on each service (such as a channel in case of TV) along with a short summary or commentary for each program.

FIG. 1 is an illustrative block diagram showing the principle for providing the fixed ESG which can be used by users in the traditional TV broadcasting network freely. As shown in FIG. 1, server 100 includes an aggregator 101, a fixed ESG creator 102 and a broadcaster 103. Services from service operators 105 are provided to the aggregator 101, the aggregator 101 aggregate these services, and the fixed ESG creator 102 will generate a fixed ESG according to the services information in the aggregator 101. Then, the fixed ESG creator 102 transmits the fixed ESG to the broadcaster 103 for broadcasting to service subscribers 104 via a broadcasting network. The service subscribers 104 connect to the broadcasting network in wire mode (such as 104 (2) and 104(3)) or wireless mode (such as 104 (1)). The above components in server 100 can be located on one server machine or several separate devices.

In recent years, there is a trend to offer TV services through IP networks, including mobile communication networks. Different from traditional TV broadcasting network, some IP networks are location dependent, which makes location dependent services and programs possible. For example, using WiFi (Wireless Fidelity) network to extend mobile TV (e.g. DVB-H) to cover WiFi portable devices can be implemented for users at home and hotspots. Since the home region and/or hotspots are varying in location, user profiles, events and system capacity, the content to be broadcasted over the WiFi network may also be varying a lot for each local network.

Therefore, the programs or services available for a distributed mobile TV operation, such as mobile TV over WiFi networks, can be much more diversified than a centralized mobile TV operation, such as DVB-H (Digital Video Broadcasting-handhold). Users at neighboring access points (APs) of a WiFi network can be offered a completely different set of TV programs; therefore, The fixed ESG can not meet the requirement of the WiFi user, and different ESG/EPG are required.

In addition, in a location dependent network, there can be hundreds or even thousands of hotspots with location dependent service/contents. If the fixed ESG in the traditional TV broadcasting network is used in each hotspot or location, it will need to make hundreds or even thousands copies of ESG for the whole network in a region. And when the network is updated, the corresponding fixed ESG must be updated as well. Therefore, automatic ESG creation adaptive to the dynamics of networks and subscribers is important for TV over IP networks.

In view of the above, we have to tackle the above mentioned problem by generating a dynamic ESG or a hybrid ESG which combines the fixed ESG and the dynamic ESG, as a function of user information which is different for each hotspot or location. In addition to users' location, depending upon users' profile and access time, dynamic or hybrid ESG can be generated to guide users with the available program fitting to users' status.

### SUMMARY OF THE INVENTION

An object of the invention is to provide a dynamic ESG or a hybrid ESG service function for users in the video broadcasting network base on the user information.

Another object of the invention is to provide a dynamic ESG or hybrid ESG service function for users of TV over IP networks which is variable based on the hotspot or location of the user, the profile and access time and the like. It defines the system framework and primitive components required for such a dynamic ESG service function.

According to one aspect of the invention, provide A method for generating Electronic Service Guide, comprising steps of: obtaining user information from a user in a digital video broadcasting network; generating a first Electronic Service Guide as a function of the user information, wherein the first Electronic Service Guide lists services provided by the digital video broadcasting network and associated with the user information; and sending the first Electronic Service Guide to the user.

According to one embodiment of the invention, the digital video broadcasting network includes a plurality of local networks for providing services for users therein respectively, and the user information is location information for indicating one of the local networks where the user is located, so that the first Electronic Service Guide lists services provided by the one of the local networks.

According to one embodiment of the invention, the method further comprises generating a second Electronic Service Guide for listing services which can be used by users in the digital video broadcasting network freely, and combining the second Electronic Service Guide with the first Electronic Service Guide before the step of sending. The local networks are WiFi network, and each WiFi network provides video broadcasting services to users therein.

According to another aspect of the invention, provide a device for generating Electronic Service Guide, comprising: a memory for storing user information from a user in a digital video broadcasting network; a generator for generating a first Electronic Service Guide as a function of the user information, wherein the first Electronic Service Guide lists services provided by the digital video broadcasting network and associated with the user information; and a broadcaster for sending the first Electronic Service Guide to the user.

### BRIEF DESCRIPTION OF DRAWINGS

FIG. 1 is an illustrative block diagram showing the principle for providing the fixed ESG in the traditional TV broadcasting network;

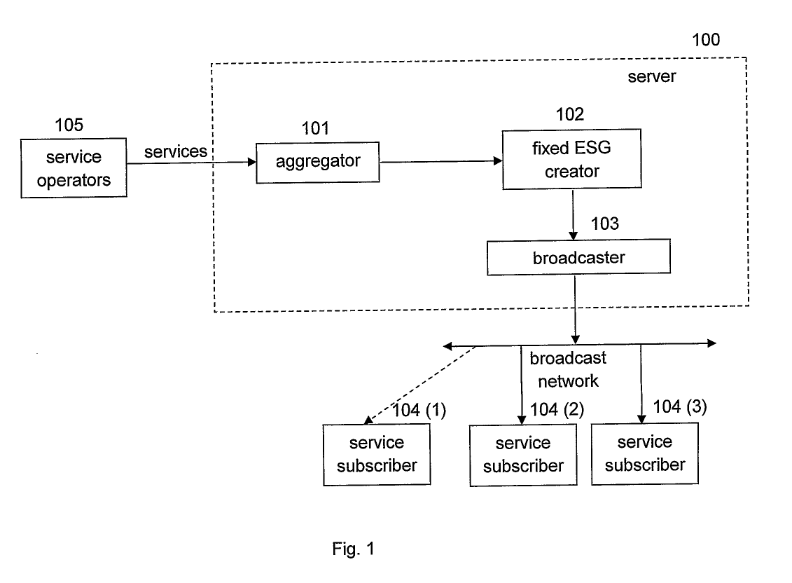

FIG. 2 is an illustrative diagram showing the network architecture including various local networks;

FIG. 3 is an illustrative block diagram showing the principle for providing the dynamic ESG according to an embodiment of the invention; and

FIG. 4 is a flow chart for generating dynamic ESG according to an embodiment of the invention.

### DETAIL DESCRIPTION OF PREFERRED EMBODIMENTS

A description will now be given with reference to attached figures to illustrate many advantages/features of the present invention, according to illustrative embodiment of the present invention. In the attached figures, the like figure numbers indicate the similar elements.

Although WiFi network herein is used as an exemplary location dependent local network in the embodiment of the invention, other local wire or wireless digital networks can also be used, such as Bluetooth and the like. Therefore, the explanation and examples herein is just to illustrate, but not to limit the invention.

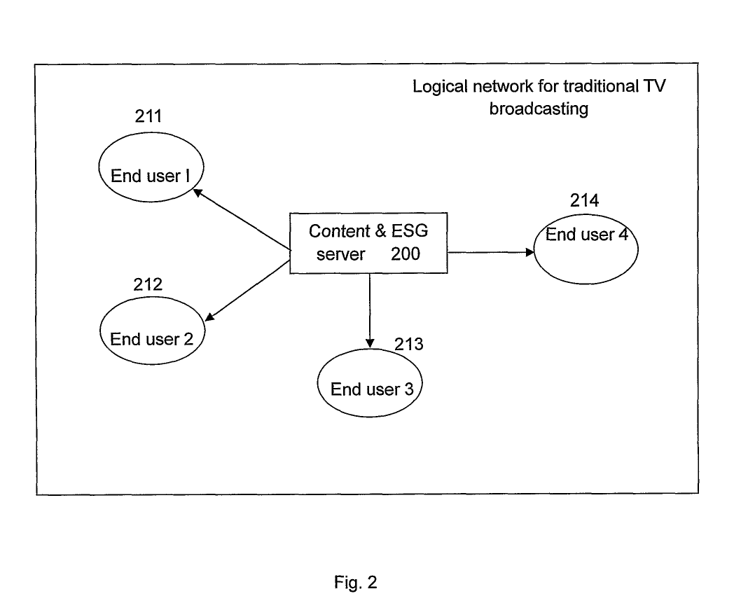

FIG. 2 is an illustrative diagram showing the network architecture including various local networks. A description will now be given to illustrate the configuration of the network based on the WiFi network.

In general, the traditional TV broadcasting network 210 covers a large area, such as a big city, a province or even a country. Now, with the development of various local IP networks, such as WiFi network, TV programs and other services can be provided within such local networks.

The WiFi network with the function of providing TV service can cover some hotspots, a home region, a business, an apartment, and so forth. The local networks 211-214 are the exemplary illustration of such WiFi network, which covers a smaller area than the traditional digital TV broadcasting network 210, and within the network 210.

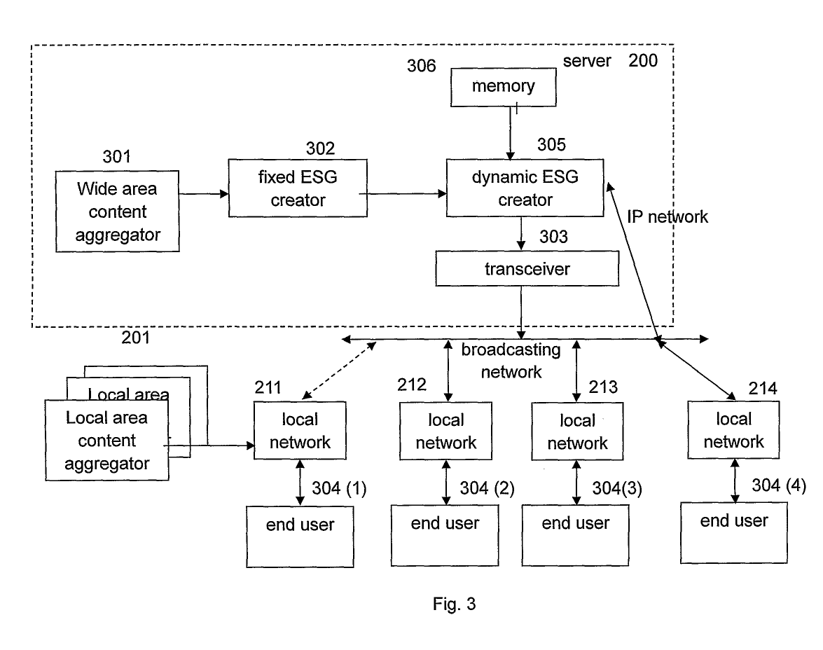

In addition, it is apparent to one skilled in the art that the local networks can be different with each other. For example, some of them can be WiFi network, and others can be Bluetooth network. According to the embodiment of the invention, the exemplary end users 1-4 located in the coverage range of these local networks can be connected to server 200 of the traditional TV broadcasting network 210 via respective access point (AP) by wire or wireless link. It is known to one skilled in the art that other various connection styles can also be used. The detailed description of server 200 will be given according to FIG. 3.

User device of the service subscriber/user within the WiFi network can be implemented as a set-top box, a satellite receiver, a TV recorder, a computer with television capabilities, an information appliance, and so forth.

The user device can include a wireless port, such as an infrared or WiFi wireless port, for receiving wireless communications from a remote control device or various services, a handheld input device, such as a keyboard, for inputting required information. In addition, the user device can include a wire port, such as internet port to receive various control information or services.

FIG. 3 is an illustrative block diagram showing the principle for providing the dynamic ESG or hybrid ESG according to an embodiment of the invention.

ESG contains information about the services available. Through the information in the ESG, the user can select the services and items he/she is interested in. In practice, user device can be located in anywhere of the network, and each local network can provide different services. Therefore, delivering the ESG within the whole network consume bandwidth whereas delivering continuously the minimal required ESG exploit more efficiently the bandwidth, and it will confuse the available services with other services. The minimal required ESG, that is, a dynamic ESG shall be based on the user information, such as the location of the user and their requirements.

The dynamic ESG may list current and scheduled programs in the digital video broadcasting network, which are or will be available on each channel along with a short summary or commentary for each program, and are associated with the user information. The dynamic ESG also lists all the services associated with the user information: video-on-demand, interactive applications, etc., which the subscriber/user will be able to access through the ESG catalogue displayed on his portal.

In the embodiment as shown in FIG. 3, server 200 includes aggregator 301, fixed ESG creator 302, memory 306, dynamic ESG creator 305 and transceiver 303, wherein, similar to the prior art, the aggregator 301 aggregates the services from the services operators, including services from each local network. In addition, the local network can have respective aggregator 201 to aggregate the services of each local network and provide the services to the aggregator 301. The fixed ESG creator 302 generates a fixed ESG which can be used by all users freely, according to the services information from the traditional TV broadcasting network and aggregated in the aggregator 301.

In addition, in the WiFi network, user devices in the local networks 211-214 can connect with the dynamic ESG creator 305 via IP network, so the transceiver 303 can be bypassed.

Some user information, such as user's location, access time when the user device accesses the traditional digital video broadcasting or the local networks, requirements of the user, user profile, and so forth, are stored in the memory 306 in associated with the services. The dynamic ESG creator 305 generates a dynamic ESG according to the user information, such as the location and other information of the user.

For example, if a user device of one of the end users 304 (1-4) is located in local network 213, and the user inputs a requirement for movie by the user device or other available devices to transfer to the server 200 via the broadcasting network, wherein the user device can be any available device, as long as the server can obtain the user information from the user. The server 200 obtains the location information indicating the local network 213 via a location device (not shown in the figure), such as a GPS location device, and obtains the requirements via the transceiver 303. The dynamic ESG creator 305 retrieves services associated with the location information and the requirement from the memory 306. Then, a dynamic ESG is generated from the services corresponding to local network 213 and the required services (such as movie). Then, the dynamic ESG is transmitted to the user device via the transceiver 303.

Alternatively, the dynamic ESG can be combined with the fixed ESG from the fixed ESG creator 302 to generate a hybrid or combined ESG. The hybrid ESG is transmitted to the user device in the local network 213.

In one embodiment of the invention, an end user can directly send request to the server 200 with the parameters of his location information (such as SSID or location name) and the user's ID. The server 200 will process the request (generate the ESG by location and user profile, and put the result on a HTTP server), then response with the information of an URL. Using this URL, the end user can get the ESG file generated by the server. The client program resided on the device of the end user will periodically check the handover of wireless connection, when the end user roaming to another coverage area, the client program will send a request to the server and tell the server the new location information so that the server will send new URL for ESG of this location. All this procedure will be transparent to the user.

The server 200 can be centralized or distributed to hotspot networks. From management and cost considerations, a centralized server can be used for dynamic ESG.

It is known that both unicast and multicast can be used and have their drawbacks and advantages in ESG delivery system architecture. Unicast consumes the network resources only when the user is actively access the ESG, and the ESG can be customized according to the user's profile. The main drawback of unicast is its scalability problem if there are too many users accessing the ESG simultaneously. Multicast transmission has the advantage to be received by multi-users consumed the minimum network resources, but not reliable in wireless network and can not provide customized services guide to the users.

Therefore, a hybrid ESG delivery method which is a tight integration between the unicast and multicast can fulfill the needs of Mobile TV services over WiFi networks. The ESG can be offered on-demand over unicast by the end user, and/or delivered over multicast by the server.

In addition, in order to be compliant with the broadcasting network, the service guide is encoded in CBMS XML-based format or other suitable format. Therefore, it is fully compliant with the DVB-IPDC CBMS format. This reduces the implementation costs in terminal software which can be used in both DVB_H and WiFi terminal; also make it possible for use to switch from DVB_H to WiFi or WiFi to DVB-H seamlessly.

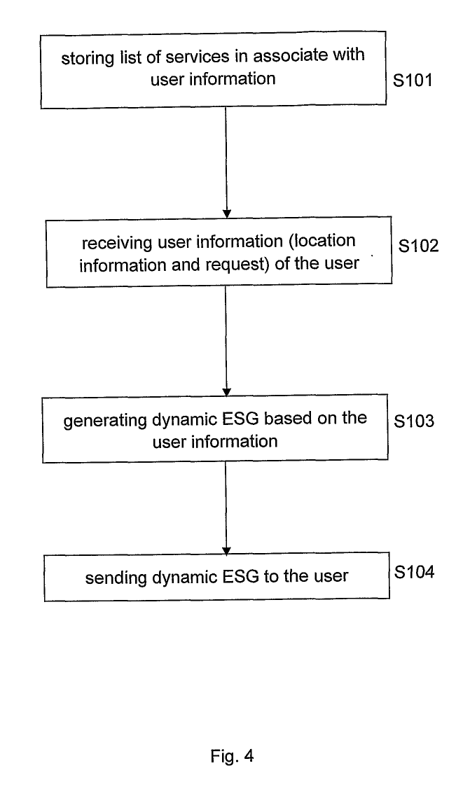

FIG. 4 is a flow chart for generating dynamic ESG according to an embodiment of the invention.

At step S101, storing a list of services associated with the user information in the memory 306. Then, at step 102, user information, such as location information and request of the user, etc. are received from the user in the broadcasting network via corresponding devices. At step 103, based on the above user information, a dynamic ESG is generated, the dynamic ESG lists services associated to the user information, and at step 104, the dynamic ESG is send to the user by the transceiver via the broadcasting network.

As described above, according to the embodiment of the invention, a dynamic ESG or a hybrid ESG is transmitted to the user device based on the location information and the requirement of the user, so that the required bandwidth to transmit the ESG is reduced, and it is clear for users to see the available services for them.

Although the specific configuration and the flow based on the embodiment of the present invention is described above, it cannot be considered to be a limit to the present invention. For example, the location information and requirements of the user are used to describe the embodiment of the invention, it is apparent to one skilled in the art to use other information, such as the user profile and the access time, as long as a dynamic ESG can be generated as a function of the user information.

In addition, the dynamic ESG or the hybrid ESG can be generated based on one of the information of the user information, or the combination of some of the information.

The term “dynamic ESG” is used in the embodiment of the invention, it means that the ESG is not fixed for users at each local network, instead the ESG can be changed based on the location information or other information, and then the changeable ESG can be sent to the user device.

The server 200 is used to illustrate the embodiment of the invention. However, it is apparent to one skilled in the art to use other device in the network to generate the dynamic ESG.

The foregoing merely illustrates the principles of the invention and it will thus be appreciated that those skilled in the art will be able to devise numerous alternative arrangements which, although not explicitly described herein, embody the principles of the invention and are within its spirit and scope. It is to be understood that numerous modifications may be made to the illustrative embodiments and that other arrangements may be devised without departing from the spirit and scope of the present invention as defined by the appended claims.

1-12. (canceled)

13. A method for generating Electronic Service Guide, comprising steps of:
obtaining user information from a user in a digital video broadcasting network□and
generating a first Electronic Service Guide as a function of the user information, wherein the first Electronic Service Guide lists services provided by the digital video broadcasting network and associated with the user information.

14. The method according to claim 13, wherein the digital video broadcasting network includes a plurality of local networks for providing services to users therein respectively, and the user information is location information for indicating one of the local networks where the user is located currently, so that the first Electronic Service Guide lists services provided by the one of the local networks.

15. The method according to claim 13, wherein the user information is requirement for services inputted by the user or access time when a user device of the user accesses the digital video broadcasting network.

16. The method according to claim 13, further comprising sending the Electronic Service Guide to the user.

17. The method according to claim 13, further comprising generating a second Electronic Service Guide for listing services which can be used by users in the digital video broadcasting network freely, and combining the second Electronic Service Guide with the first Electronic Service Guide.

18. The method according to claim 14, further comprising generating a second Electronic Service Guide for listing services which can be used by users in the digital video broadcasting network freely, and combining the second Electronic Service Guide with the first Electronic Service Guide.

19. The method according to claim 16, further comprising generating a second Electronic Service Guide for listing services which can be used by users in the digital video broadcasting network freely, and combining the second Electronic Service Guide with the first Electronic Service Guide before the step of sending.

20. A device for generating Electronic Service Guide, comprising:
a transceiver for obtaining user information from a user in a digital video broadcasting network□and
a generator for generating a first Electronic Service Guide as a function of the user information, wherein the first Electronic Service Guide lists services provided by the digital video broadcasting network and associated with the user information.

21. The device according to claim 20, wherein the digital video broadcasting network includes a plurality of local networks for providing services to users therein respectively, and the user information is location information for indicating one of the local networks where the user is located currently, so that the first Electronic Service Guide lists services provided by the one of the local networks.

22. The device according to claim 20, wherein the user information is requirement for services inputted by the user or access time when a user device of the user accesses the digital video broadcasting network.

23. The device according to claims 20, wherein the transmitter is used to send the Electronic Service Guide to the user.

24. The device according to claim 20, wherein the generator further generates a second Electronic Service Guide for listing services which can be used by users in the digital video broadcasting network freely, and combines the second Electronic Service Guide with the first Electronic Service Guide.

25. The device according to claim 21, wherein the generator further generates a second Electronic Service Guide for listing services which can be used by users in the digital video broadcasting network freely, and combines the second Electronic.

26. The device according to claim 23, wherein the generator further generates a second Electronic Service Guide for listing services which can be used by users in the digital video broadcasting network freely, and combines the second Electronic before sending.
